(19) United States
(12) Patent Application Publication
(10) Pub. No.: US 2010/0277612 A1
(43) Pub. Date: Nov. 4, 2010

(54) MEMORY MANAGEMENT IN AN IMAGE STORAGE DEVICE

(76) Inventor: Michael Ryan Weber, San Francisco, CA (US)

Correspondence Address: NORTH WEBER & BAUGH LLP, 2479 E. BAYSHORE ROAD, SUITE 707, PALO ALTO, CA, 94303, US

(21) Appl. No.: 12/434,605

(22) Filed: May 1, 2009

(51) Int. Cl. H04N 5/76

(52) U.S. Cl. 348/231.2; 348/E05.031

(57) ABSTRACT

The present invention discloses methods and apparatuses for managing the memory of an image storage device. Compressed image data is organized into multiple compression layers. The present invention takes advantage of the compression layers to free up additional storage space in memory when necessary.

### BACKGROUND

A. Technical Field

The present invention pertains generally to memory management, and relates more particularly to managing the memory of an image storage device, such as a digital camera.

B. Background of the Invention

Image storage devices, including digital cameras, have become ubiquitous in today's society. As users capture more digital images and the number of megapixels per image continues to increase, the storage space needed to store the images also increases. Compression is used to reduce the amount of data required to store each captured image. Most digital cameras use lossy compression, which significantly reduces the amount of data needed to represent an image, but at the expense of a loss in quality. Digital cameras typically offer different quality settings for each captured image. For example, many digital cameras allow the user to select between high, medium and low quality levels. Images captured with the camera set to a low quality level are severely compressed resulting in smaller compressed image file sizes, at the expense of reduced image quality. By contrast, images captured with a high quality level are not as severely compressed, resulting in images with better quality at the expense of larger compressed image file sizes. A medium quality level provides a balance between the resulting compressed image file size and the quality of the image.

One problem with most digital cameras is that the quality level, and the corresponding compressed image file size, of an image cannot be changed in the camera after the image data has been compressed and stored to memory. One consequence is that when the memory of the camera is full, if the user wants to take additional photos, the user must either delete one or more photos from memory or replace the external memory card with a new card. If another external memory card is not available, the user's only option is to delete one or more images from memory.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a block diagram of a generic compression encoder 100 according to one embodiment of the invention.

FIG. 2A is an example of a representative 8×8 block 200 of DCT coefficients.

FIG. 2B is an example of a zig-zag scanning order for an 8×8 block 210 according to one embodiment of the invention.

FIG. 3A is a block diagram showing one alternative for organizing compressed image data into compression layers according to one embodiment of the invention.

FIG. 3B is a block diagram of a second alternative for organizing compressed image data into compression layers according to one embodiment of the invention.

FIG. 4 is a block diagram of an image storage apparatus 400 according to one embodiment of the present invention.

FIG. 5 is a flow diagram of a method 500 for adjusting a quality level of an image stored in the memory of an image storage device according to one embodiment of the invention.

FIG. 6 is a flow diagram of a method 600 for increasing the quality of images stored in memory of an image storage device according to one embodiment of the invention.

FIG. 7 is a flow diagram of a method 700 for managing the storage space in a memory of an image storage device according to one embodiment of the invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, firmware, or combinations thereof. Accordingly, the figures described herein are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

The present invention discloses methods and apparatuses for managing the storage space available in a memory of an image storage device, such as a digital camera. The present invention takes advantage of compression codecs that order compressed image data in compression layers rather than according to the spatial orientation of the data within the image to increase the quality and number of images that may be stored in the memory.

In one embodiment, compressed image data is organized into multiple compression layers. For example, a first compression layer may include data sufficient to recreate a crude, low quality representation of the image and a second compression layer may include additional enhancement data that adds additional detail to an image. In this embodiment, the first layer may be referred to as a base layer and the second layer may be referred to as an enhancement layer. This concept may be extended further to include multiple enhancement layers, each having additional data that increases the quality of the reproduced image.

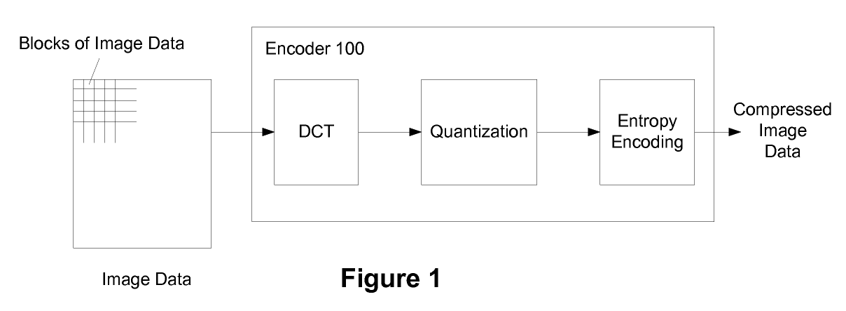

Many image compression codecs, including JPEG and HD Photo (currently being considered for standardization as JPEG XR), utilize a transform function (e.g. discrete cosine transform (DCT)) in the compression of image data. FIG. 1 is a block diagram of a generic transform-based encoder 100 that uses a DCT transform. In one embodiment, the encoder 100 receives the image data to be compressed. In one embodiment, the image data may be organized into luminance and chrominance components as is well known to one skilled in the art. The luminance component represents the luminance of the image while the chrominance components represent the color components of the image.

In one embodiment, the image data is divided into blocks for processing. In the examples described herein, the data is organized into 8×8 blocks of image data. Although the examples described herein utilize 8×8 blocks, one skilled in the art will recognize that the invention will work with image blocks of any size. In this example, a transform function, such as a discrete cosine transform (DCT) is applied to each block of image data. The DCT transforms the image data from a spatial representation to a frequency-based representation as is well known in the art. The output of the DCT block is an 8×8 block of 64 DCT coefficients.

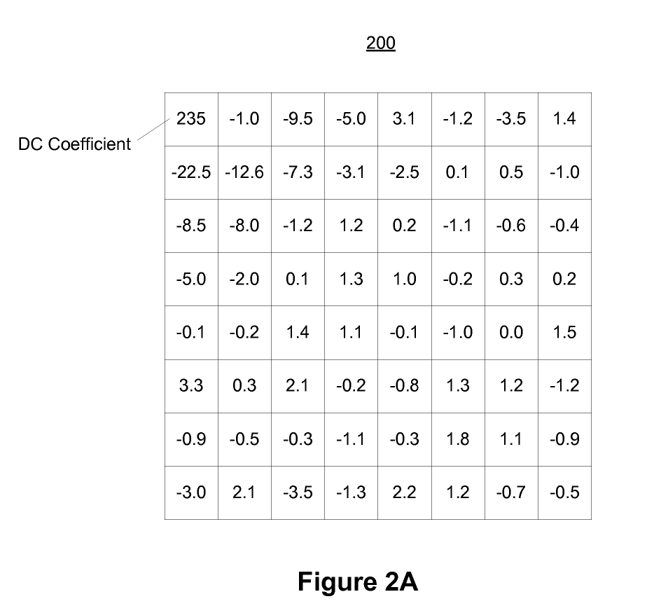

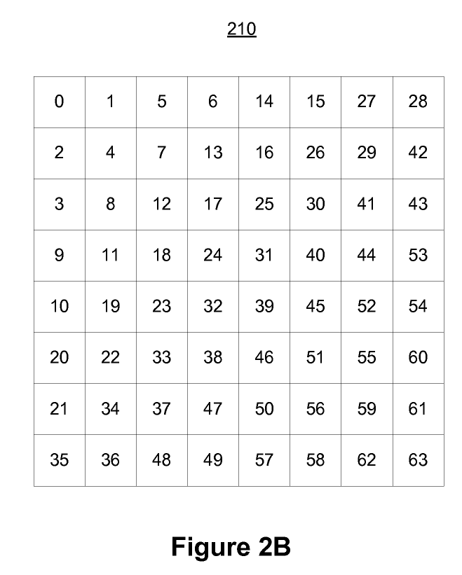

FIG. 2A is an example of an 8×8 block 200 of DCT coefficients. The coefficient in the upper left hand corner of the block is the DC coefficient. The DC coefficient represents the average value of the 64 image samples in the block. The rest of the coefficients are the AC coefficients which represent frequency components of the block of image samples. The AC coefficients surrounding the DC coefficient represent low frequency components. Moving away from the DC coefficient in the horizontal and vertical directions, the higher the frequency component. The coefficient in the lower right corner of block 200 is the highest frequency coefficient of block 200.

FIG. 2B is a diagram of a representative zig-zag scanning position for each of the coefficients of an 8×8 block of coefficients. The numbers in each smaller block within block 210 represent the zig-zag scanning order of the respective coefficient in the block rather than coefficient values.

In one embodiment, the DCT coefficients are quantized according to a quantizing value. The quantizing value may be a single value that is applied to quantize each coefficient in a block or may vary for each coefficient within a block. For example, many compression schemes use a quantization table comprised of 64 quantizer values. Each coefficient of the DCT block is quantized by the corresponding quantizer value in the quantization table. The quantized values of each block are ordered according to a zig-zag scanning pattern, an example of which is provided in FIG. 2B. This zig-zag scanning pattern orders the coefficient values from low frequency to high frequency. The data is transmitted to an entropy encoder where the quantized coefficients are entropy encoded using Huffman encoding or some other form of entropy encoding. A similar compression scheme is used in a variety of compression formats, including, MPEG, JPEG and others.

Since the human visual system is more receptive of low frequency changes in an image than high frequency changes, the high frequency coefficients are typically quantized more heavily than the lower frequency components. In one embodiment of the invention, the compressed image data is organized into multiple compression layers by grouping like frequency coefficients for all of the blocks that make up an image. For example, a first compression layer may comprise the DC coefficient from each block of image data. A second compression layer may comprise the first AC coefficient from each block, etc.

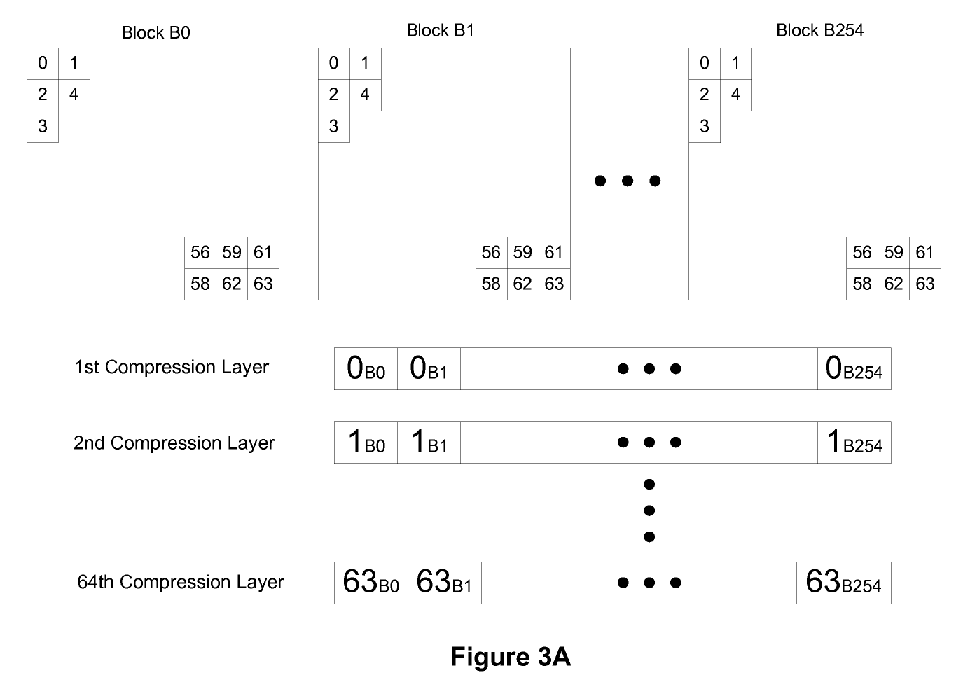

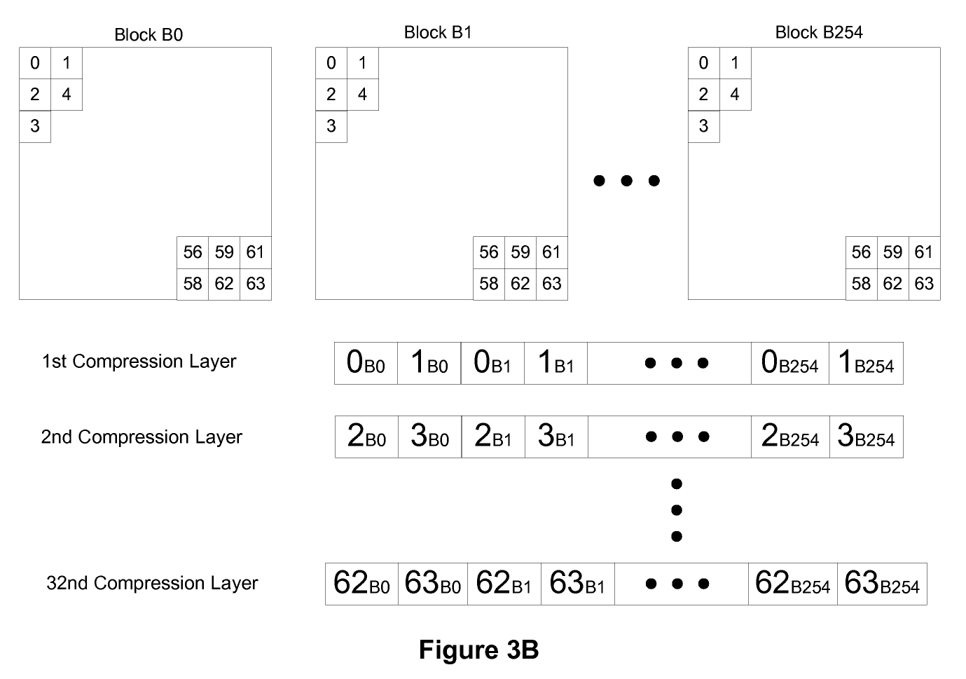

FIG. 3A is a block diagram showing one alternative for organizing compressed image data into compression layers according to one embodiment of the invention. FIG. 3A shows 255 8×8 blocks (B0-B254) of DCT coefficients that make up a sample image according to one embodiment of the invention. In FIG. 3A, the numbers in blocks B0-B254 represent an order of importance of the coefficients to a reconstruction of the image rather than coefficient values. In this embodiment, a first compression layer is comprised of each DC coefficient (coefficient “0”) from each of the 255 blocks. A second compression layer is comprised of the first AC coefficient from each block (coefficient “1”), etc. As shown in FIG. 3A, this embodiment results in the compressed image data being organized into 64 compression layers.

In another embodiment, shown in FIG. 3B, the data is organized into a first compression layer by taking the DC coefficient and the first AC coefficient from each block. In this embodiment, the first compression layer is comprised of the DC coefficient (coefficient “0”) and the first AC coefficient (coefficient “1”) from each block. A second compression layer is comprised of the second AC coefficient (coefficient “2”) and the third AC coefficient (coefficient “3”) from each block, etc. As shown in FIG. 3B, this embodiment results in the compressed image data being organized into 32 compression layers.

It should be noted that these are just two examples of how the compressed image data may be organized into compression layers. The present invention is not limited to the grouping of data into compression layers as described above. One skilled in the art will recognize that there are a number of ways to group image data into compression layers within the scope of the present invention. Additional examples of ways for grouping coefficients are found in U.S. Pat. No. 5,339,108, U.S. Pat. No. 6,804,402, and the HD Photo Feature Specification, Version 1.0 which are herein incorporated by reference. All of the groupings described in these documents may be used to organize the data into multiple compression layers that may take advantage of the present invention.

### Apparatus Implementations

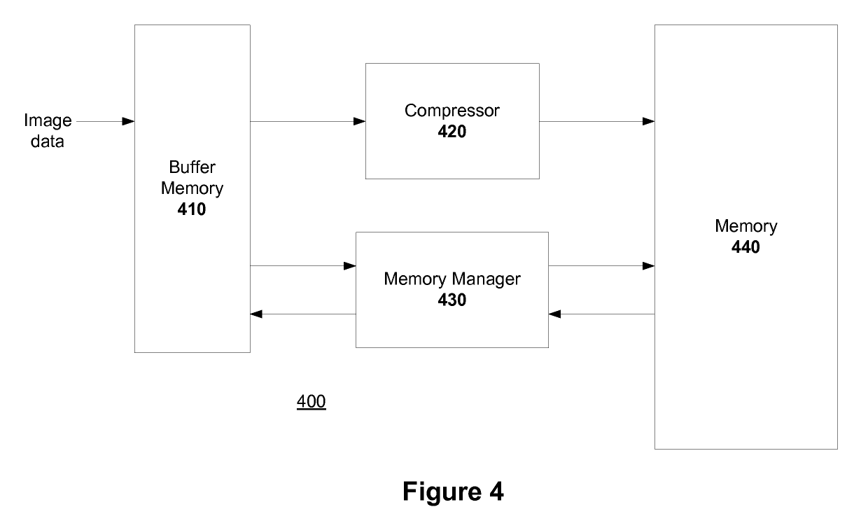

FIG. 4 is a block diagram of an image storage apparatus 400 according to the present invention. Various embodiments of the present invention will be described herein that utilize apparatus 400. Apparatus 400 comprises a buffer memory 410, a compressor 420, a memory manager 430 and a memory 440. As shown in FIG. 4, buffer memory 410 is coupled to compressor 420 and memory manager 430. Compressor 420 and memory manager 430 are also coupled to memory 440.

In one embodiment, buffer memory 410 receives image data. For example, the buffer memory may receive raw image data representing an image from a charge-coupled device (CCD) of a digital camera or other capture device. As discussed previously, in one embodiment, the image data may be divided into luminance and chrominance components as is well known in the art. Buffer memory 410 stores the raw image data and transmits the raw image data to compressor 420. In one embodiment, the image data is transmitted from buffer memory 410 to compressor 420 in 8×8 blocks of image data. One skilled in the art will recognize that buffer memory 410 may be implemented using volatile or non-volatile memory, including, but not limited to hard disk memory, magnetic tape, optical discs or flash memory.

In one embodiment, compressor 420 compresses the image data and groups the compressed image data into multiple compression layers. As discussed previously, there are a number of ways to organize the compressed data into multiple compression layers according to the present invention. Compressor 420 is not limited to a specific compression codec. Example codecs that may be implemented by compressor 420 include but are not limited to JPEG, HD Photo, and JPEG XR. One skilled in the art will recognize that compressor 420 may be implemented in hardware or software. Further, hardware implementations may be implemented using a general purpose processor or an implementation specific processor, such as a digital signal processor (DSP).

In one embodiment, memory 440 receives the compressed image data from compressor 420 and stores the compressed image data in a file within memory 440. One skilled in the art will recognize that memory 440 may be implemented using volatile or non-volatile memory, including, but not limited to hard disk memory, magnetic tape, optical discs or flash memory.

### Implementation 1

In one embodiment of the invention, the image storage device takes advantage of the compression layers to increase the quality of stored images. In one embodiment, compressor 420 receives a quality level for each image. For example, the quality level may be set by a user for each image or may be a static quality level for each image. For example, a digital camera may allow the user to specify between three different quality levels for each image, e.g. low, medium and high quality. One skilled in the art will recognize that there are a number of ways to define quality for an image. For example, the quality level may limit the amount of storage space that may be used to store the compressed image data for the image or the file containing the compressed image data (hereinafter the “compressed image file size”). Alternatively, the quality level may limit the number of compression layers that may be stored to memory for an image.

In one embodiment, memory manager 430 monitors the available storage space in memory 440. As long as the available storage space is above a threshold level, compressor 420 compresses each image to a higher quality than the received quality level. For example, the compressor may initially compress an image with a received quality level of medium to the highest quality level. The compressor also organizes the compressed image data into a plurality of compression layers. In one embodiment, the received quality level is associated with the image data and becomes a minimum quality level for the image. One skilled in the art will recognize that if the received quality level is static for each image, the quality level does not need to be stored with each image. However, if the received quality level may vary for each image, the received quality level may be stored with its respective compressed image data.

In one embodiment, when the available storage space falls below the threshold level, the memory manager 430 deletes one or more compression layers from the compressed image data of one or more images stored in memory 440. This frees up additional storage space in memory 440 but reduces the quality of the images from which the compression layers are deleted. One skilled in the art will recognize that the memory manager 430 may be implemented in software or hardware. Further, hardware implementations may be implemented using a general purpose processor or an implementation specific processor, such as a digital signal processor (DSP).

In one embodiment, the number of compression layers that may be deleted from a respective image depends on the minimum quality level associated with the image. In one embodiment, one or more compression layers may be deleted from an image so long as the quality of the image does not fall below the minimum quality level associated with that image. As discussed previously, there are a number of ways to define the quality of an image, including the compressed image file size. For example, assume the minimum quality level for an image defines a limit of the compressed image file size for an image with that quality level. If the compressed image file size of the image is above this compressed image file size limit (i.e. a higher quality than the minimum quality level), one or more compression layers may be deleted to reduce the compressed image file size of the image. Once the compressed image file size falls below the compressed image file size limit defined by the minimum quality level, no additional compression layers may be deleted from the image without reducing the quality of the image below the minimum quality level.

Alternatively, if the quality of an image is defined based on the number of compression layers that may be used to store the compressed image data of the image, the memory manager 430 may delete that number of compression layers above that defined by the minimum quality level associated with the image. For example, assuming a compressed image has thirty compression layers and an associated minimum quality level that defines twenty compression layers for a compressed image, up to ten compression layers may be deleted from the compressed image data to free up additional storage space in memory.

In one embodiment, memory manager 430 deletes the compression layers from the compressed image data in memory 440. Memory manager 430 may also update the header information for the image file to account for the deleted compression layers. In an alternative embodiment, memory manager 430 may copy the image file, containing the compressed image data, to buffer memory 410. The memory manager 430 may then delete the one or more compression layers from the compressed data in the image file and update the header information of the image file to account for the deleted compression layers. The image file, minus the deleted compression layers, is transmitted to memory 440 for storage.

This embodiment allows the image storage device to maximize the available storage space and potentially store one or more images at a higher quality than its respective received quality level. So long as the image storage device stores less than a number of images that would normally fill up the memory of the image storage device at the specified received quality level(s), one or more images will be stored in memory at a higher quality. Since the compressed image data is organized in one or more compression layers, the image data may easily be provided to a user or other device at the higher quality or at the specified (i.e. received) quality level. Further, if additional images are later selected for storage to the memory, additional compression layers may be deleted from those images that are stored in memory at quality levels above their minimum quality level. This may be particularly beneficial in a digital camera.

### Implementation 2

In one embodiment, compressor 420 compresses image data received from buffer memory 410 according to a received quality level. For example, the quality level may be set by a user for each image or may be a static quality level for each image. The compressed image data is organized into compression layers and transmitted to memory 440 for storage. In one embodiment of the invention, as the available storage space in the memory decreases, the user may choose to select a lower quality level for one or more of the images stored in memory 440 to free up additional storage space.

In response to receiving a request to reduce the quality of a selected image, the memory manager 430 deletes one or more compression layers from the compressed image data of the selected image until the quality of the image is reduced to the newly selected quality level. This reduces the quality of the image but frees up additional storage space within the memory that may be used to store additional images. For example, if the quality level defines a compressed file size limit for each compressed image, one or more compression layers may be deleted from the compressed image data until the compressed file size limit defined by the lower quality level is satisfied. As another example, if the quality level defines a number of compression layers that may be used to store compressed image data, a number of compression layers in the compressed image data above the limit are deleted to reduce the quality of the image to the lower quality level.

In one embodiment, memory manager 430 deletes the compression layers from the compressed image data in memory 440. Memory manager 430 may also update the header information for the image file to account for the deleted compression layers. In an alternative embodiment, memory manager 430 may copy the image file, containing the compressed image data, to buffer memory 410. The memory manager 430 may then delete the one or more compression layers from the compressed data in the image file and update the header information of the image file to account for the deleted compression layers. The image file, minus the deleted compression layers, is transmitted to memory 440 for storage.

This embodiment allows the user to change the quality level of an image previously compressed and stored to memory 440 without the need to decompress and recompress the image data at a different quality level. Decompressing image data and recompressing the image data at a different quality level (e.g. different quantization factor) introduces defects into the image and also consumes battery power. By contract adjusting the quality level according to the present invention by deleting one or more compression layers from the compressed data stored in memory 440 can be performed quickly and efficiently without introducing defects into the compressed image data.

### Implementation 3

In one embodiment, compressor 420 compresses the image data received from buffer memory 410 according to a received quality level. For example, the quality level may be set by a user for each image or may be a static quality level for each image. The compressed image data is organized into multiple compression layers as discussed previously. In one embodiment, memory manager 430 detects that there is not sufficient storage space available in memory 440 to store the compressed image data. In this embodiment, only a subset of the compression layers may be stored to memory 440. In one embodiment, the memory manager 430 determines how many compression layers will fit within the remaining storage space in memory and causes the transfer to memory 440 of only those compression layers that will fit within the remaining available storage space in memory 440.

For example, if the user selects a quality level of high for an image, compressor 420 will compress the received image data at the high quality level. Assume for purposes of this example that the compressed image data at the high quality level results in thirty compression layers of data. If the memory manager 430 determines that the thirty compression layers cannot all fit within the remaining available storage space of memory 440, memory manager 430 will determine how many of the compression layers will fit within the available storage space in memory 440. For example, if memory manager 430 determines that only the fifteen most important compression layers will fit within the remaining storage space, memory manager 430 will cause only those fifteen compression layers to be stored to memory 440. This results in a lower quality image being saved to memory 440 than originally desired by the user. However, storing a lower quality image is better than not storing any version of the image.

### Method Embodiments

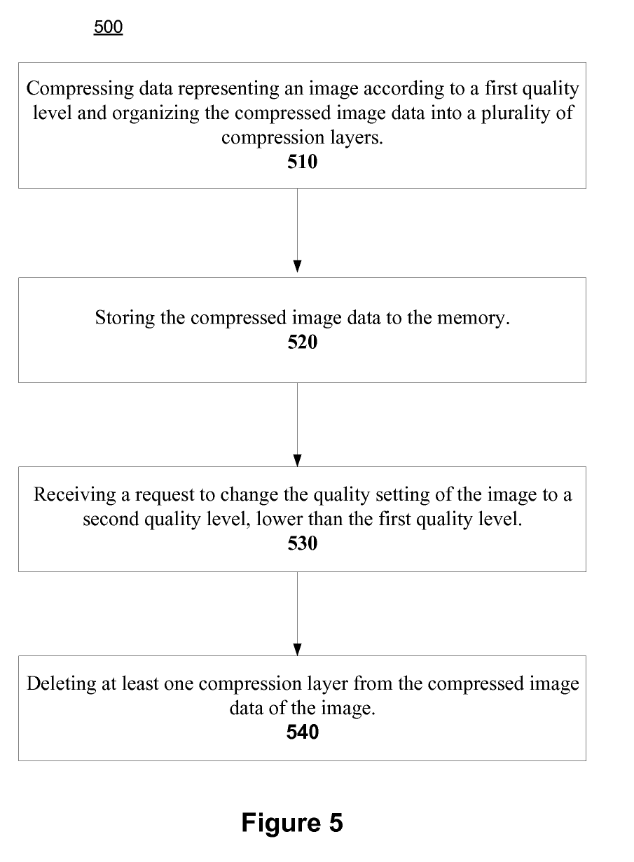

FIG. 5 is a flow diagram of a method 500 for adjusting a quality level of an image stored in the memory of an image storage device, such as a digital still camera, according to one embodiment of the invention. In step 510, the data representing an image is compressed according to a first quality level and organized into a plurality of compression layers. In one embodiment, the first quality level is selected by a user. In another embodiment, the first quality level is the same for each compressed image. As discussed previously, one skilled in the art will recognize that the quality level of an image may be defined in a number of ways, including a compressed image file size limit and/or a limit to the number of compression layers for an image. The compressed image data may be generated from images captured by the image storage device or images transmitted to the image storage device from an external source.

In step 520, the compressed image data is stored to memory.

In step 530, a request is received to change the quality setting of the image to a second quality level, the second quality level being lower than the first quality level. In one embodiment, the image storage device receives the request to change the quality setting of an image stored in memory from a user. For example, the user may wish to reduce the quality level for one or more images stored in memory to free up additional storage space in the memory to store additional data, such as additional images. In order to free up additional storage space in memory, the second quality level is a lower quality level than the first quality level so that one or more compression layers are deleted from the compressed image data.

In step 540, at least one compression layer is deleted from the compressed image data of the image. In one embodiment, one or more compression layers are deleted from the compressed image data of the selected image until the quality of the image is reduced to that defined by the second quality level. Deleting one or more compression layers from the compressed image data results in reducing the quality of the image but also frees up available storage space in memory.

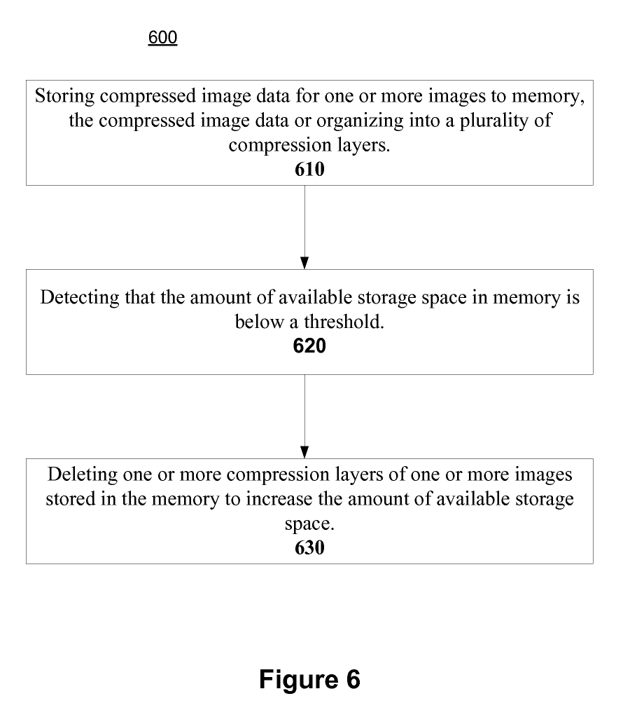

FIG. 6 is a flow diagram of a method 600 for increasing the quality of images stored in memory of an image storage device according to one embodiment of the invention. In step 610, compressed image data for one or more images is stored to memory, the compressed image data organized into a plurality of compression layers. In one embodiment, a quality level is received for each image. For example, a user may specify a quality level for each image or the quality level may be static for each image. In one embodiment, as long as the amount of available storage space in memory is above a threshold level, each image is compressed at a higher quality level than the received quality level. In this embodiment, the received quality level is associated with each respective image and becomes a minimum quality level. One skilled in the art will recognize that if the received quality level is static for each image, the quality level does not need to be stored with each image. However, if the received quality level may vary for each image, the received quality level may be stored with its respective compressed image data.

In step 620, the image storage device detects that the amount of available storage space is below a threshold. One skilled in the art will recognize that there are a number of ways to define the threshold. For example, the threshold level may be the average space needed to store the compressed image data of a typical image.

In step 640, one or more compression layers for one or more images are deleted from memory to increase the amount of available storage space in memory. As discussed previously, in one embodiment, image data is compressed at a higher quality level than the received quality level. As a result, the quality of the images may be reduced by deleting one or more compression layers. In one embodiment, the number of compression layers that may be deleted from each image depends on the minimum quality level associated with each image. In one embodiment, one or more compression layers may be deleted from an image so long as the quality of the image does not fall below the minimum quality level associated with that image.

As discussed previously, there are a number of ways to define the quality of an image, including the compressed image file size. For example, assume the minimum quality level for an image defines a limit of the compressed image file size for an image. In one embodiment, if the compressed image file size of the image is above the file size limit, one or more compression layers may be deleted to reduce the compressed image file size of the image. Once the compressed image file size falls below the limit defined by the minimum quality level, no additional compression layers may be deleted from the image because this would reduce the quality of the image below the minimum quality level.

Alternatively, if the quality of an image is defined based on the number of compression layers that may be used to store compressed image data of the image, the memory manager 430 may delete that number of compression layers above that defined by the minimum quality level associated with the image. For example, assuming a compressed image has thirty compression layers and an associated minimum quality level that defines twenty compression layers for a compressed image, up to ten compression layers may be deleted from the compressed image data to free up additional storage space in memory.

This allows the image storage device to maximize the available storage space and potentially store one or more images at a higher quality. So long as the image storage device stores less than a number of images that would normally fill up the memory of the image storage device at the minimum quality level(s), one or more images will be stored in memory at a higher quality. Since the compressed image data is organized in one or more compression layers, the image data may easily be provided to a user or other device at the higher quality or at the specified quality level. Further, if additional images are later selected for storage to the memory, additional compression layers may be deleted from those images that are stored in memory at quality levels above their minimum quality level. This may be particularly beneficial in a digital camera.

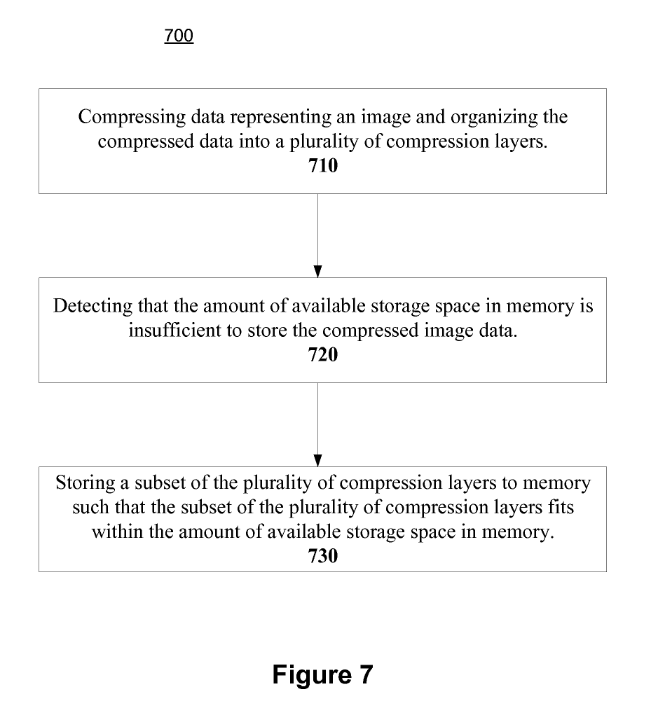

FIG. 7 is a flow diagram of a method 700 for managing the storage space in memory of an image storage device according to one embodiment of the invention. In step 710, data representing an image is compressed and organized into a plurality of compression layers. In step 720, the device detects that the amount of available storage space in memory is insufficient to store the compressed image data.

In step 730, a subset of the plurality of compression layers are stored to memory such that the subset of the plurality of compression layers fits within the amount of available storage space in memory. In one embodiment, the device determines how many compression layers may fit within the available storage space. This subset of the compression layers is stored to the available storage space in memory. The remainder of the compression layers are discarded. While this reduces the quality of the image, it allows for the storage of a lower quality version of the image rather than nothing at all.

It shall be noted that embodiments of the present invention may further relate to computer products with a computer-readable medium that have computer code thereon for performing various computer-implemented operations. The media and computer code may be those specially designed and constructed for the purposes of the present invention, or they may be of the kind known or available to those having skill in the relevant arts. Examples of computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a computer. Examples of program modules include libraries, programs, routines, objects, components, and data structures. In distributed computing environments, program modules may be physically located in settings that are local, remote, or both.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. An apparatus for storing digital images, comprising
a compressor for receiving image data representing an image, compressing the image data and outputting the compressed image data in a plurality of compression layers;
a memory, coupled to the compressor, for receiving and storing the compressed image data;
a memory manager, coupled to the memory, for monitoring an amount of available storage space in the memory, detecting when the amount of available storage space is less than a threshold, and deleting one or more compression layers from one or more images stored in memory.

2. The apparatus of claim 1 wherein the one or more compression layers are deleted from one or more images until the amount of available storage space in the memory is above the threshold.

3. The apparatus of claim 1 wherein the apparatus is a digital camera.

4. The apparatus of claim 1 wherein a minimum quality level is associated with each image and a number of compression layers deleted from the compressed image data of an image is limited such that a quality of the image does not fall below the minimum quality level associated with the image.

5. The apparatus of claim 4 wherein the minimum quality level for each image is determined by a user.

6. A method for managing an amount of available storage space in a memory of an image storage device, comprising:
storing compressed image data for one or more images to memory, the compressed image data organized into a plurality of compression layers;
detecting that the amount of available storage space in the memory is below a threshold; and
deleting one or more compression layers of the compressed image data of one or more images stored in the memory.

7. The method of claim 6 wherein a minimum quality level is associated with each image and a number of compression layers deleted from the compressed image data of an image is limited such that a quality of the image does not fall below the minimum quality level associated with the image.

8. The method of claim 7 wherein the minimum quality level for each image is determined by a user.

9. The method of claim 6 wherein the image storage device is a digital camera.

10. A method for managing an amount of available storage space in a memory of an image storage device, comprising:
compressing data representing an image according to a first quality level and organizing the compressed image data into a plurality of compression layers;
storing the compressed image data to the memory;
receiving a request to change a quality setting of the image to a second quality level lower than the first quality level;
deleting at least one compression layer from the compressed image data of the image.

11. The method of claim 10 wherein one or more compression layers are deleted from the compressed image data until the compressed image data has a quality defined by the second quality level.

12. The method of claim 10 wherein the quality setting defines a compressed image file size limit for the compressed image data.

13. The method of claim 12 wherein one or more compression layers are deleted from the compressed image data until the compressed image file size limit defined by the second quality level is satisfied.

14. The method of claim 10 wherein the quality setting defines a number of compression layers in the compressed image data.

15. The method of claim 14 wherein one or more compression layers are deleted from the compressed image data until the number of compression layers defined by the second quality level is satisfied.

16. An apparatus for storing digital images, comprising
a compressor for receiving image data representing an image, compressing the image data according to a first quality level and outputting the compressed image data in a plurality of compression layers;
a memory, coupled to the compressor, for receiving and storing the compressed image data;
a memory manager, coupled to the memory, for receiving a request to change a quality setting of the compressed image data to a second quality level lower than the first quality level, and deleting one or more compression layers from the compressed image data of the image.

17. The apparatus of claim 16, wherein one or more compression layers are deleted from the compressed image data until the compressed image data has a quality defined by the second quality level.

18. The apparatus of claim 16, wherein the quality setting defines a compressed image file size limit for the compressed image data.

19. The apparatus of claim 18, wherein one or more compression layers are deleted from the compressed image data until the compressed image file size limit defined by the second quality level is satisfied.

20. The apparatus of claim 16, wherein the quality setting defines a number of compression layers compressed image data.

21. The apparatus of claim 20 wherein one or more compression layers are deleted from the compressed image data until the number of compression layers defined by the second quality level is satisfied.
